(19) United States
(12) Patent Application Publication
(10) Pub. No.: US 2007/0052824 A1
(43) Pub. Date: Mar. 8, 2007

(54) Cutting method for fabricating a color wheel

(75) Inventors: Pi-Tsung Hsu, Hsinchu (TW); Hsin-Li Lin, Hsinchu (TW)

Correspondence Address: BIRCH STEWART KOLASCH & BIRCH, PO BOX 747, FALLS CHURCH, VA, 22040-0747, US

(73) Assignee: PREMIER IMAGE TECHNOLOGY CORPORATION

(21) Appl. No.: 11/515,862

(22) Filed: Sep. 6, 2006

(30) Foreign Application Priority Data
Sep. 6, 2005 (TW) 094130470

(51) Int. Cl. H04N 9/083

(52) U.S. Cl. 348/270

(57) ABSTRACT

A cutting method for fabricating a color wheel. The first step includes cutting a set of fan-shaped filter segments from different colored filter sheets, wherein the sum of the included angles of the set of fan-shaped filter segments is either greater or less than 360°. The second step includes bonding the set of fan-shaped filter segments onto a metal ring. The third step includes cutting the outer edge of the set of fan-shaped filter segments along a circular path coaxial to the metal ring. In this way, while bonding the fan-shaped filter segments onto the metal ring, the effect of burrs, irregular cracks or irregular edges resulting from the cutting process can be minimized. Moreover, the outer edge of the color wheel will be coaxial to the axis of the metal ring.

### FIELD OF THE INVENTION

This invention relates to a cutting method for preparing a plurality of fan-shaped filter segments that can be bonded onto a metal ring to form a filter ring area in different colors, and finally, cutting the outer edge of the ring area coaxial with the metal ring.

### BACKGROUND OF THE INVENTION

Color wheels in prior art, typically, made by holding the three filters in a machined aluminum wheel. As the forces generated by the wheel in rotation, a metal hub and rim are adopted to keep the wheel intact. Metal spokes run from the hub to the rim along the joint between the filters to hold the filters in place. The metal wheel must be precisely aligned and balanced to ensure the smooth operation of the color wheel.

U.S. Pat. No. 5,371,543 suggests a segment-type color wheel without wheel hub and spoke, uses a base of disk bonded a plurality of fan-shaped filter segments in different colors. It not only lower the cost but also avoid the defect of spoke. U.S. Pat. No. 5,868,482 provides another color wheel uses a round metal ring coaxially symmetrically bonded a set of fan-shaped filter segments.

FIG. 1 schematically showing a conventional and typical segment-type color wheel proceed in bonding a set of fan-shaped filter segments (11A, 11B, 11C, 11D) onto a metal ring (12). Each of the fan-shaped filter element is cut by machine separately, thus would needs a high degree of accuracy in positioning, and requires ultimately go through an alignment process to keep perfect roundness of the out edge of the color wheel (10) for preventing the generation of vibration and noises at the time of high speed spinning.

In traditional design concept, all the segments should be connected by the way of edge-by-edge without left any gap when prepare it to bond onto the metal ring (12). In this way, all the fan-shaped filter segments (11A, 11B, 11C, 11D) should be machined perfectly and precisely in size and shape. Anyhow, within the cutting process, some irregular edges, burrs, cracks, poor roundness may accidentally be happened. Any imperfect alignment and positioning between the fan-shaped filter segments (11A, 11B, 11C, 11D) would cause a poor roundness and low dynamic equilibrium of the color wheel, that would cause vibrations and noises at the time of high speed rotation.

Due to the fan-shaped filter segments are provided separately by cutting machine, and there are some defects may accidentally occurred at the edge and tips of the filter segments, such as burrs, cracked edges; therefore the segment-type color wheel always require a high degree of accuracy in positioning.

### SUMMARY OF THE INVENTION

The object of the invention is to provided a cutting method for fabricating a color wheel, that can lower the effect arisen from the burrs, irregular cracks or irregular edges, and improves the roundness of the outer edge of color wheel.

To achieve the objects as described above, the method according to the present invention may including a first step of cutting a set of fan-shaped filter segments from different colors filter sheets, wherein the sum of the included angles of the set of fan-shaped filter segments is either greater or less than 360°; a second step of bonding the set of fan-shaped filter segments onto a metal ring; and a third step of cutting the outer edge of the set of fan-shaped filter segments along a circular path coaxial with the metal ring.

By this way, while proceed to bond the fan-shaped filter segments onto the metal ring, the effect which may arisen from the burrs, irregular cracks or irregular edges occurred accidentally in cutting process would be lower. Moreover, the outer edge of the color wheel will then be perfectly coaxial with the axis of the metal ring by the cutting or grinding of the third step according to the present invention, that would prevents the generation of vibrations and noises at the time of high speed spinning.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 is a schematic view showing a prior art segment-type color wheel in bonding step.

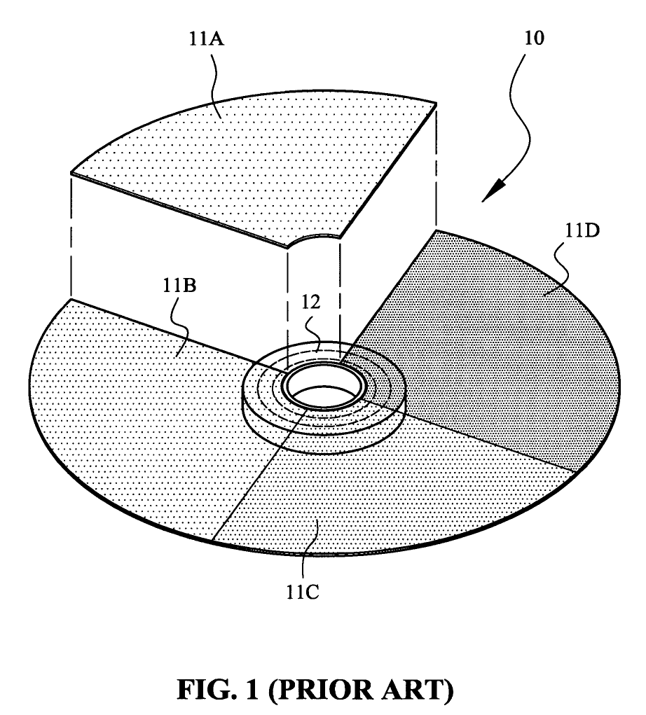

FIG. 2 is a schematic view showing an embodiment of a set of fan-shaped color filter segment according to the present invention.

FIG. 3 is a schematic view showing an alternative embodiment of the set of fan-shaped color filter segment according to the present invention.

FIG. 4 is a schematic view showing another alternative embodiment of the set of fan-shaped color filter segment according to the present invention.

FIG. 5 is a schematic view showing an alternative embodiment of the set of fan-shaped color filter segment according to the present invention.

FIG. 6 is a schematic view showing an alternative embodiment of the set of fan-shaped color filter segment according to the present invention.

FIG. 7 is a schematic view showing the third step of cutting the outer edge of the color wheel according to the present invention.

### DETAILED DESCRIPTION OF THE PREFERRED EMBODIMENTS

The cutting method according to the present invention, basically is including: a first step of cutting a set of fan-shaped filter segments from different colors filter sheets; a second step of bonding the set of fan-shaped filter segments onto a metal ring; a third step of cutting the outer edge of the set of fan-shaped filter segments along a circular path coaxial with the metal ring.

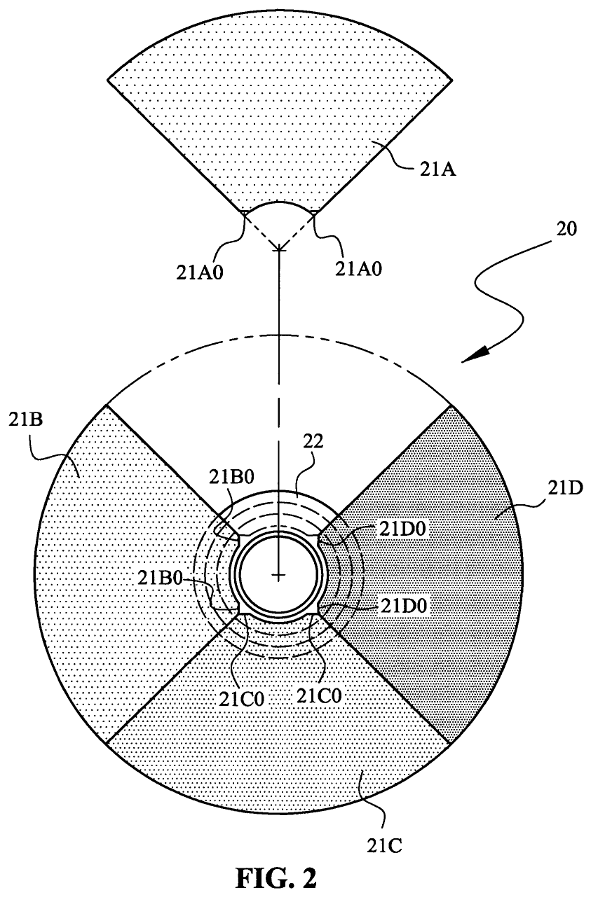

Referring to the embodiment of color wheel (20) as shown in FIG. 2, when proceeding the first step, preferably, further including to trim or grind off the inner angle tips (21A0, 21B0, 21C0, 21D0) of the fan-shaped filter segments (21A, 21B, 21C, 21D). The fan-shaped filter segments (21A, 21B, 21C, 21D) are used to bond onto the metal ring (22) to form a ring area of filter in different colors.

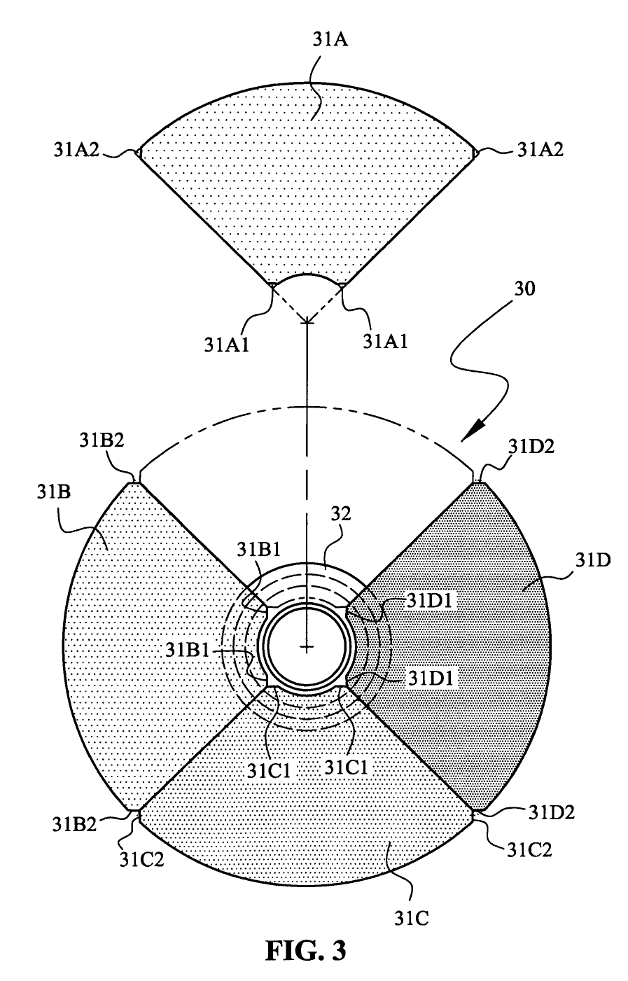

Referring to the alternative embodiment of color wheel (30) as shown in FIG. 3, when proceeding the first step, preferably, further including to trim or grind off the inner angle tips (31A1, 31B1, 31C1, 31D1) and the outer angle tips (31A2, 31B2, 31C2, 31D2) of the fan-shaped filter segments (31A, 31B, 31C, 31D). By this way, to avoid the burrs that possibly existed at the tips interfereing with each other. In the second step, The fan-shaped filter segments (31A, 31B, 31C, 31D) are bonded onto metal ring (32) to form a ring area of filter in different colors.

The cutting method according to the present invention, may alternatively including: a first step of cutting a set of fan-shaped filter segments from different colors filter sheets, wherein the sum of the included angles of the set of fan-shaped filter segments is either be greater or less than 360°; a second step of bonding the set of fan-shaped filter segments onto a metal ring; a third step of cutting the outer edge of the set of fan-shaped filter segments along a circular path coaxial with the metal ring.

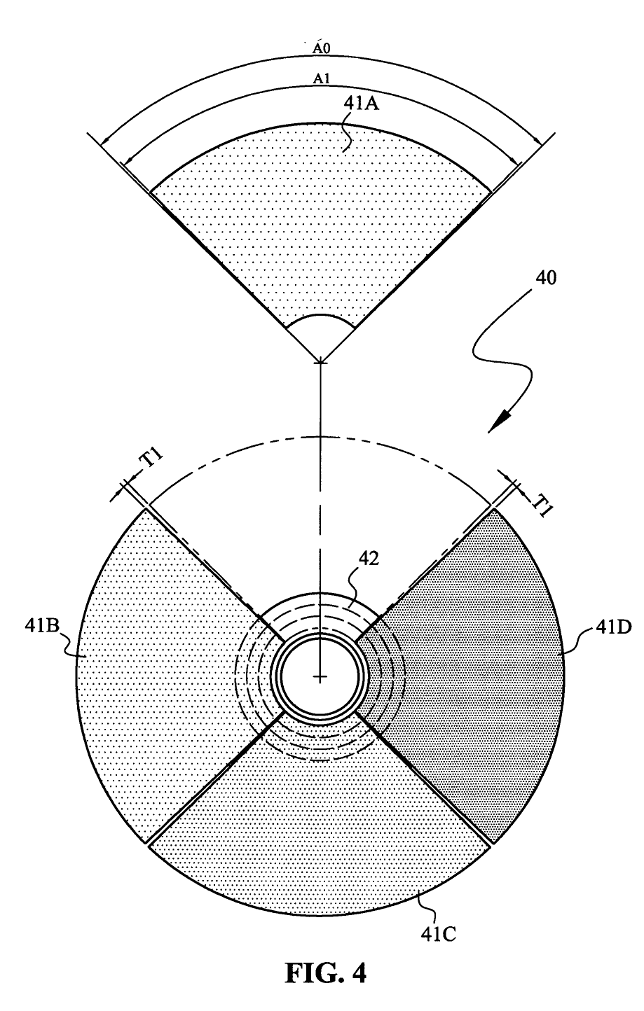

Referring to the alternative embodiment of color wheel (40) as shown in FIG. 4, the sum of the included angle (Al) of the fan-shaped filter segments (41A, 41B, 41C, 41D) is less than 360°. In traditional design concept, the sum of the included angle (A0) should precisely machined to be 360°; however, if any burrs or cracked edges have accidentally occurred at the edges of the fan-shaped filter segments (41A, 41B, 41C, 41D), there is no more possible to have a perfect assembly as the designer's wish. The outwardly angle gap (T1) between the fan-shaped filter segments (41A, 41B, 41C, 41D) is designed to avoid the possible influence which may arisen from the burrs or cracked edges between the edges of the fan-shaped filter segments (41A, 41B, 41C, 41D). In the second step, the fan-shaped filter segments (41A, 41B, 41C, 41D) are bonded onto the metal ring (42) to form a ring area of filter in different colors.

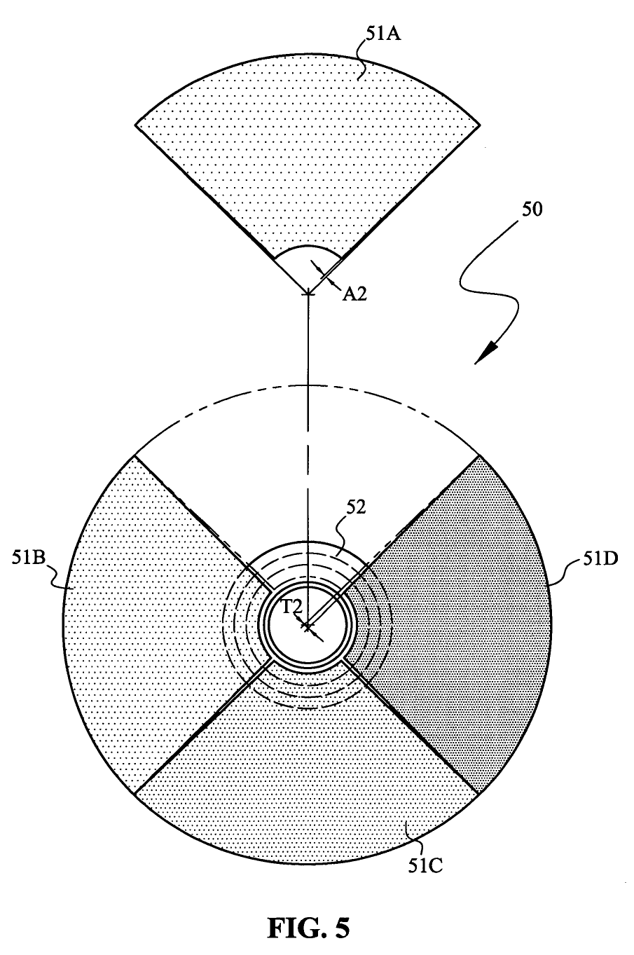

Referring to another alternative embodiment of color wheel (50) as shown in FIG. 5 has different features from FIG. 5, including the sum of the included angle of the fan-shaped filter segments (51A, 51B, 51C, 51D) is less than 360° that would formed an inwardly angle gap (A2). The inwardly angle gap (A2) is designed to avoid the possible influence arisen from the burrs or cracked edges which may existed at the edges and the tips of the fan-shaped filter segments (51A, 51B, 51C, 51D). In the second step, The fan-shaped filter segments (51A, 51B, 51C, 51D) are used to bond onto metal ring (52) to form a ring area of filter in different colors.

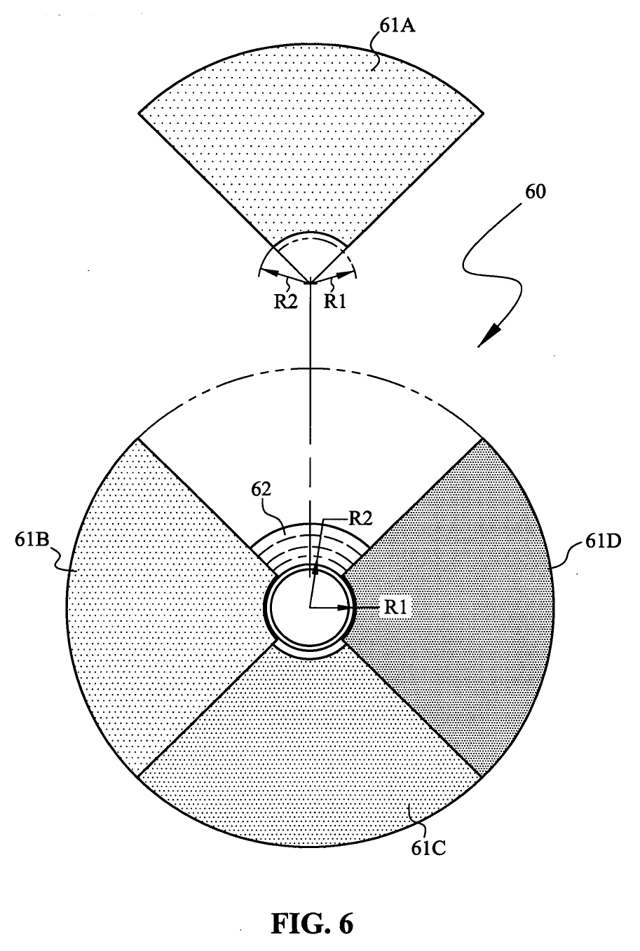

Another alternative embodiment is designed to avoid the burrs which may occurred at the tips to influence the assembly of color wheel, shown in FIG. 6. This alternative embodiment allows the inner circumference of the fan-shaped filter segments to have more than one inner radius. The fan-shaped filter segments (61B, 61D) both having a first inner radius (R1), and another fan-shaped filter segments (61A, 61C) having a second inner radius (R2). The fan-shaped filter segments (61B, 61D) are symmetrically oppositely bonded onto metal ring (62) in a first direction, and another fan-shaped filter segments (61A, 61B) are also symmetrically oppositely bonded onto metal ring (62) in second direction. Due to the inner radius (R1, R2) are cutted in different size, the burrs at the angle tips shall not have chance to meet together to influence the assembly of color wheel (60).

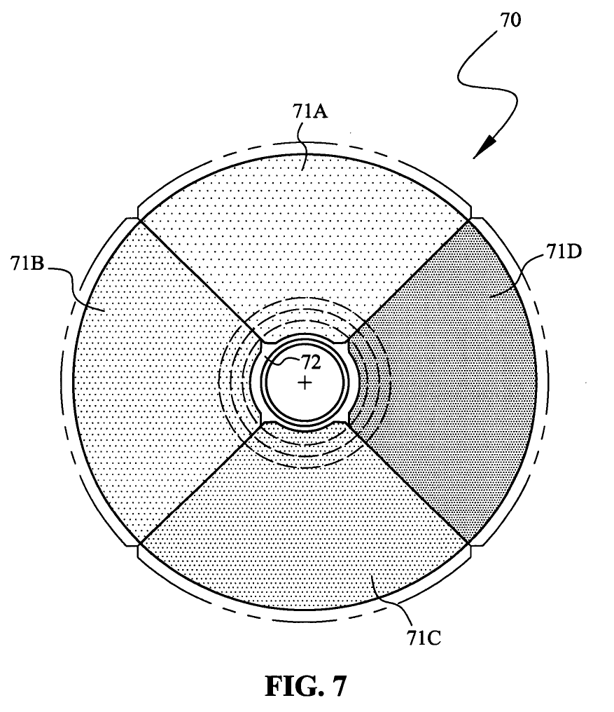

FIG. 7 is schematically showing the third step of cutting the outer edge of the color wheel (70) according to the present invention. When the fan-shaped filter segments (71A, 71B, 71C, 71D) is bonded on to the metal ring (72), cutting or grinding the outer edge of the set of fan-shaped filter segments (71A, 71B, 71C, 71D) along a circular path which coaxial with the metal ring. By this step, the outer edge of the color wheel will then become perfectly coaxial with the axis of the metal ring by the cutting of the third step of the present invention, would prevents the generation of vibrations and noises at the time of high speed spinning.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A cutting method for fabricating a color wheel, comprising:
a first step of cutting a set of fan-shaped filter segments from different colored filter sheets, wherein the sum of the included angles of the set of fan-shaped filter segments is greater than 360°;
a second step of bonding the set of fan-shaped filter segments onto a metal ring; and
a third step of cutting the outer edge of the set of fan-shaped filter segments along a circular path coaxial to the metal ring.

2. The cutting method according to claim 1, wherein the first step further comprises trimming the corners of the fan-shaped filter segments.

3. The cutting method according to claim 1, wherein the first step further comprises cutting a first fan-shaped filter segment with a first inner radius, and a second fan-shaped filter segment with a second inner radius.

4. A cutting method for fabricating a color wheel, comprising:
a first step of cutting a set of fan-shaped filter segments from different colored filter sheets, wherein the sum of the included angles of the set of fan-shaped filter segments is less than 360°;
a second step of bonding the set of fan-shaped filter segments onto a metal ring; and
a third step of cutting the outer edge of the set of fan-shaped filter segments along a circular path coaxial to the metal ring.

5. The cutting method according to claim 4, wherein the first step further comprises trimming the corners of the fan-shaped filter segments before advanced to the second step.

6. The cutting method according to claim 4, wherein the first step further comprises cutting a first fan-shaped filter segment with a first inner radius, and a second fan-shaped filter segment with a second inner radius.

7. A cutting method for fabrication a color wheel, comprising:
a first step of cutting a set of fan-shaped filter segments from different colored filter sheets;
a second step of bonding the set of fan-shaped filter segments onto a metal ring; and
a third step of cutting the outer edge of the set of fan-shaped filter segments along a circular path coaxial to the metal ring.

8. The cutting method according to claim 7, wherein the first further comprises trimming the corners of the fan-shaped filter segments.

9. The cutting method according to claim 7, wherein the first step further comprises cutting a first fan-shaped filter segment with a first inner radius, and a second fan-shaped filter segment with a second inner radius.
